(19) United States
(12) Patent Application Publication
(10) Pub. No.: US 2018/0115619 A1
(43) Pub. Date: Apr. 26, 2018

(54) SYSTEM AND METHOD FOR ATTACHING DIGITAL DOCUMENTS TO PHYSICAL OBJECTS

(71) Applicant: Jong Shyr Huang, Redmond, WA (US)

(72) Inventor: Jong Shyr Huang, Redmond, WA (US)

(21) Appl. No.: 15/331,814

(22) Filed: Oct. 22, 2016

(51) Int. Cl. H04L 29/08; H04W 4/00

(52) U.S. Cl. CPC H04L 67/18; H04W 4/008; H04L 67/06; H04L 67/1097

(57) ABSTRACT

A method and system are provided for attaching digital documents to physical objects. The system allows an author to divide a region on the map into hierarchical geographical contexts. One of the geographical context, Planes, are used to host photos of physical objects to which an author can attach documents. By indexing geographic contexts by GPS location, altitude, azimuth, and context path, the user application is able to navigate the geographic context by querying the backend servers for geographic context that matches the current device GPS location, altitude, and orientation. By keeping track of the context path as the user enters and exits geographic contexts, a user is able to enter a short relative ID to retrieve a document with that relative ID in the current context. This context-relative ID could be posted on any real physical object to provide a way to attach documents to real physical objects.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The present invention relates to techniques for creating, storing, and associating digital documents to physical objects using hand-held devices with GPS and Internet connection. In particular, the invention relates to techniques for augmenting GPS resolution for high precision targeting of any physical object.

### BACKGROUND OF THE INVENTION

With the advent of smart phones, tablets, and mobile devices, capturing digital content such as images, videos, and sound via built-in camera and microphone becomes easy. Furthermore, with built-in GPS, Bluetooth, Wi-Fi and sensors such as accelerometer, gyroscope, the device knows our geographic location, altitude, and orientation. As a result, every image, video, and sound captured by smart phones and similar devices already contain a vast amount of information. A smart phone or a similarly equipped device now becomes a very efficient tool for digital content acquisition and creation.

As more digital content is created, how to organize and find the desired content in an efficient manner becomes a challenge. Popular Internet services such as Google Maps and Yelp give you capability to look for business around a particular location. The technology involves mainly with geo-tagging content with latitude and longitude. By using the GPS location of a mobile device, the user can look for businesses such as restaurants near him or her. Advertisements can be served in a similar fashion.

This invention differs from the prior art by allowing a user to create or navigate digital content in a more granular manner than just “near me.” The GPS locations returned by a GPS device can be off by as much as 10 meters at best. While this precision is good enough to locate businesses near me, it is not precise enough to find physical objects near me. For example, a business may want to associate online conferencing equipment manuals to a conference room so that it is readily available for people in the conference room. A restaurant may want to associate nutrition information to any menu item so that its customers can view it. A home owner may also want to associate some planting information to an apple tree so that later on the user knows what kind of apple tree it is and its caring instructions. There are many scenarios that we want to attach digital content to physical objects, be it a thing, a wall, or a room. For example, user manuals of appliances, maintenance record of cars, wine or painting collections information, paint colors of home, . . . , etc. This invention aims to facilitate creating, and storing digital content that can be associated with any physical object. This invention further facilitates content retrieval by proximity to these physical objects using a GPS-enabled smart phone or mobile device, such as Virtual Reality goggle.

### SUMMARY OF THE INVENTION

In one aspect, this invention includes a smart phone or similar mobile device that is equipped with Internet data service, GPS, Wi-Fi, Bluetooth and optional sensors such as accelerometer, gyroscope. The smart phone or similar mobile device contains a user-facing client application that allows the user to acquire, create and consume digital content. The system also includes an Internet-based Application Programming Interface (API) layer that provides the service endpoints for the user-facing application running on the smart phone or similar mobile device. Behind the API layer is the content store for storing digital content; a media store for storing media files such as images, videos, and sound; a content index store for indexing text content and locations, altitude, orientation, and context path for searching. Other than the user facing application, the other components constitutes server components that reside in the cloud.

In another aspect, this invention includes an application running on a smart phone or similar mobile device. The application includes an authoring module for creating geographic contexts. The geographic contexts are metaphors used by this invention to help increase the location resolution on top of what can be achieved through GPS locations. There are three types of geographic contexts: Turf, Area, and Plane. The owner or custodian of a facility or property can use the authoring module to prepare digital content for potential users to navigate. Here we call the person preparing the digital content “the author.” The author first creates a Turf by either marking polygonal boundaries on a map to delineate a Turf or using a GPS location to represent a Turf. A Turf encapsulates all content within it so that the contained content is not visible on the map until the user or author enters the Turf. An author can enter his/her Turf and creates Areas in it. The purpose of Areas is to further divide a Turf into smaller areas. Areas can be nested, that is, an author can create Areas within Areas. Thus as an author or user enters a Turf, he or she can only see Areas inside the Turf. As he or she enters an Area, he or she can only see content within this particular area. We call this process Progressive Geographic Context Switching(PGCS.) Using PGCS we have a way to guide the user into a smaller and smaller area. We use these Areas as context for presenting the user relevant digital content.

In yet another aspect, this invention allows the author to create Planes within Areas. The author creates Planes by taking a sequence of photos of the surroundings of an Area. The sequence of photos can consist of one 360-degree photo or multiple photos at different angles. The purpose of these photos is to allow the user to see clearly the physical objects in this particular Area so that the author can create digital content and attach the digital content to any physical object on the photos. In general, we call the digital content an author creates “document” unless it is a geographic context. In other words, digital content consists of geographic contexts and documents. The authoring module allows the author to create documents of different types: notes, sales, business card, home inventory, events, maintenance, . . . , etc. A document is created by capturing or importing one or more pictures and input meta data according to different document types. The authoring module automatically tags all digital content with GPS location (latitude, longitude), altitude, azimuth (0-359 degrees, with 0: due north, 90: due east, 180: due south, 270: due west).

In an additional aspect, this invention includes an application running on a smart phone or similar mobile device. The application includes a navigation module for navigating and consuming digital content. Depending on the user's current GPS location, the navigation module will show turfs around the user. All Areas, Planes, documents in the Turf will not be visible until the user enters the Turf. This greatly reduces the cluttering of markers on the map. For Turfs that the user entered before, the navigation module may enter the Turf automatically if the user is near that particular Turf. The navigation module uses the device GPS location, altitude, and orientation to detect the closest Turf, Area, or Plane to help the user navigate in the geographic contexts. In addition, Bluetooth Beacons can be used to help detect precisely which geographic context the user is in. As the user navigate in Areas, the navigation module will present Planes or documents on the map that are in the correct geographic context. Again, the use of azimuth, the altitude, and GPS location will help the navigation module present relevant documents or planes to the user. On planes, the user will be able to see physical objects in the photos. Any relevant documents attached to physical objects will be visible in the planes for the user to interact with.

In yet a further aspect, a method for placing links on real physical object is provided by the authoring module. In the authoring module, an author can assign a relative ID consisting of alphanumeric characters to any document created. This is called relative ID because the ID is relative to the current geographic context. There can be identical ID's in the same Turf as long as they are in different geographic contexts. The use of relative ID is different from a URL or a QR code in that it is not globally unique. This allows authors to assign short ID's to documents, which means less input for the users. To attach a document to a real physical object requires only showing the document's relative ID. For example, an author can create a document with information and caring instructions for an apple tree then put the relative ID on the apple tree. A user can enter a short relative ID posted on the apple tree to retrieve the information and caring instructions for the apple tree when he or she is near it.

### BRIEF DESCRIPTION OF THE DRAWINGS

The present invention is described in detail below with references to the attached drawing figures, wherein:

FIG. 1 is a block diagram showing a system of the invention;

FIG. 2 is a block diagram of composition and data flow of digital content created by the invention;

FIG. 3 is a block diagram illustrating division of space into geographic contexts;

FIG. 4A is a block diagram illustrating how a user can navigate and enter a Turf;

FIG. 4B is a block diagram illustrating how a user can navigate and enter an Area inside a Turf;

FIG. 4C is a block diagram illustrating how a user can navigate a Plane inside a Turf;

FIG. 4D is a picture illustrating how a user can attach digital content to an object;

FIG. 4E is a picture illustrating how a user can view digital content attached to an object;

FIG. 5 is a block diagram illustrating navigating single-point geographic contexts;

FIG. 6 is a block diagram illustrating a method for enhancing geographic context detection using Bluetooth beacons;

### DETAILED DESCRIPTION OF THE INVENTION

The invention relates to a system for creating, and attaching digital content to any physical object by an author for later navigation by users.

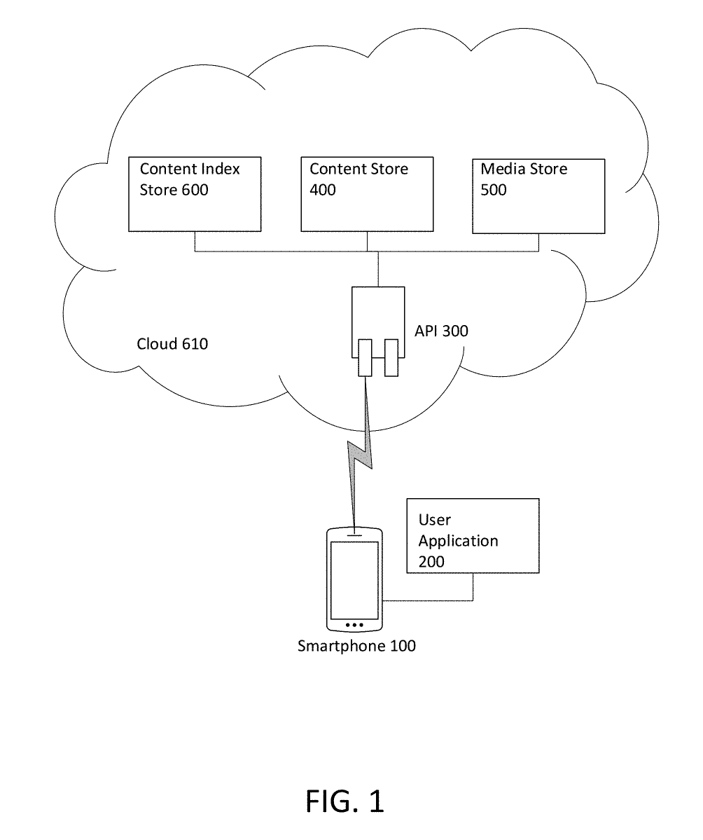

FIG. 1 illustrates a system for enabling the invention. Users of this invention will need a mobile device, such as a smartphone 100 with built-in GPS, Bluetooth, Wi-Fi and sensors such as accelerometer, and gyroscope. The use of GPS and Wi-Fi capabilities is to allow the latitude and longitude of the device to be detected. The Bluetooth capability allows the use of Bluetooth low energy (BLE) beacons to aid in the detection of geographic context by the invention. The sensors such as accelerometer, and gyroscope allows the detection of altitude and azimuth. On this smartphone 100, there is a user application 200 running that has two modes: authoring and navigation. The authoring mode is for authors to create digital content, which includes geographic context and documents, and associate documents with physical objects; whereas the navigation module is for users to navigate geographic contexts and the documents. The digital content created in the authoring module by authors are sent to the servers in the cloud 610. The digital content to be stored on the servers are received by the Application Programming Interface (API) 300, which is an abstract layer through which the application on user's device communicates with the servers in the cloud 610. The media files, such as photos, videos, and sound for the digital content are stored at the media store 500, the rest of the digital content is stored at the Content Store 400. All text portion of the digital content will be indexed by the Content Index 600, in particular, the GPS location, altitude, azimuth, relative ID, and geographic context. All queries from the user application 200 will be done through the API 300 and directed to the Content Index Store 600.

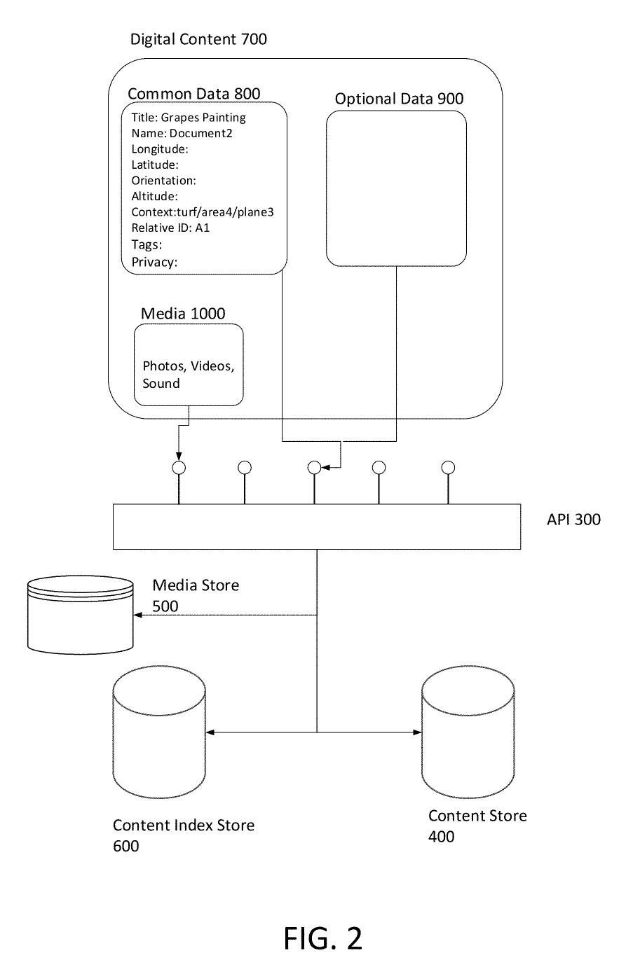

The process of creating digital content that can be attached to any physical object starts from the authoring module of the application. FIG. 2 illustrates data flow of digital content creation. There are two types of digital content created by the application: geographic contexts, and documents. Geographic contexts are used to partition a geographic space into smaller and distinguishable locations on the map. In this invention, geographic contexts consist of Turf, Areas, and Planes. Documents are structured information that includes text and a plurality of media such as photos, videos, and sounds. There are many document types that can be created, such as Maintenance, Business Card, Events, Home Inventories, Garden, . . . , etc. Authors can create custom document types as well. All digital content 700 contains a common set of Meta data 800, a plurality of media files 1000, and optional data 900 that are specific to the content type. All digital content created by authors will be sent to the API 300. The API 300 will then store the media files separately in a Media Store 500. The rest of the digital content, excluding the media files, will be stored at the Content Store 400. All text content is sent to the Content Index Store 600 to index so that we can search content by various queries.

In reference to FIG. 2, there are some Meta data in the common data 800 that will be acquired when an author uses a GPS-equipped, Internet connected mobile device such as a smartphone. These are Longitude, Altitude, azimuth, and altitude. All digital content created by the authoring module, whether a geographic context or a document, will be provided with these Meta data automatically. These Meta data will be indexed by the Content Index Store 600 when digital content is sent to the servers from the mobile device. The indexing of these Meta data allows us to query digital content by GPS locations (Longitude, latitude.) In addition, the altitude helps us differentiate geographic contexts that have similar GPS location but different altitude. An example may be different floors of a department store. The azimuth is the direction of a compass bearing in a range from 0 to 359 degrees, where due north is 0 degrees; due east is 90 degrees; due south is 180 degrees and due west is 270 degrees. This invention uses azimuth to detect where the user is facing, which in turn, helps detect which geographic context to present to the user. The use of altitude and azimuth, in addition to GPS location which is used by current art, makes the identification of nearby digital content more accurate.

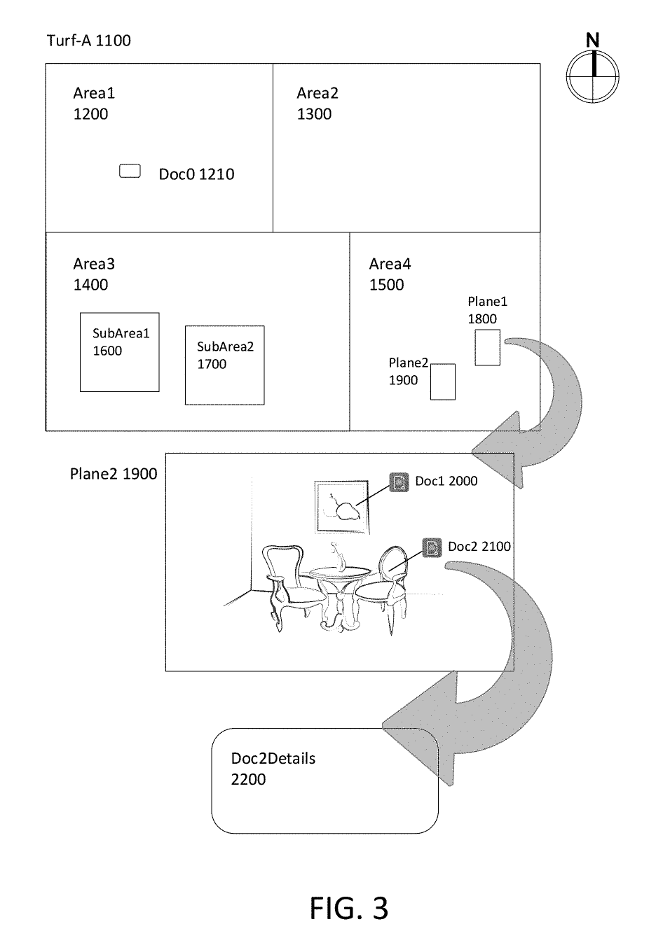

FIG. 3 illustrates how we can divide a region of interest into geographic contexts using Turf, Area, and Planes. On a mobile device, where the user application of this invention is running, we can create a Turf-A 1100 by marking a polygon boundary for the Turf-A 1100 on a map. Here we use only rectangles to enclose our geographic contexts but this invention allows any polygon as boundaries. This invention also allows for the use of one GPS location to represent any geographic context. Every geographic context should have a name. The name for a Turf should be globally unique. For other types of geographic contexts such as Areas and Planes, the names should be unique within their containing Turf. We then enter the Turf 100 and create Area1 1200, Area1 1300, Area3 1400, and Area4 1500. The purpose of Areas is to further divide Turf-A 1100 into smaller space. Likewise, we can divide Area3 1400 further by creating SubArea1 1600 and SubArea2 1700. This invention allows the division of space into geographic contexts as granular as we like. An author can place documents in any geographic context. For example, Doc0 1210 in Areal 1200. This makes Doc0 1210 accessible in the geographic context it was created. To associate a document with a physical object, an author needs to create a Plane first. In Area4 1500, we have Plane1 1800, Planet 1900. A plane is one or more photos of the surroundings of a geographic context. For example, Plane1 1800 in Area4 1500 contains a photo of an eastern view of a living room. An author may attach a home inventory document Doc1 2000 to a painting on the wall by placing a marker for home inventory document. An author may attach another home inventory document Doc2 2100 to a side chair by placing another marker for home inventory. The author may place the document markers directly on the objects or use lines to point to the objects. The author can view or edit a document by tapping on the document markers. For example, the author may tap on the marker Doc2 2100 and document details Doc2Details 2200 may be revealed for viewing or editing.

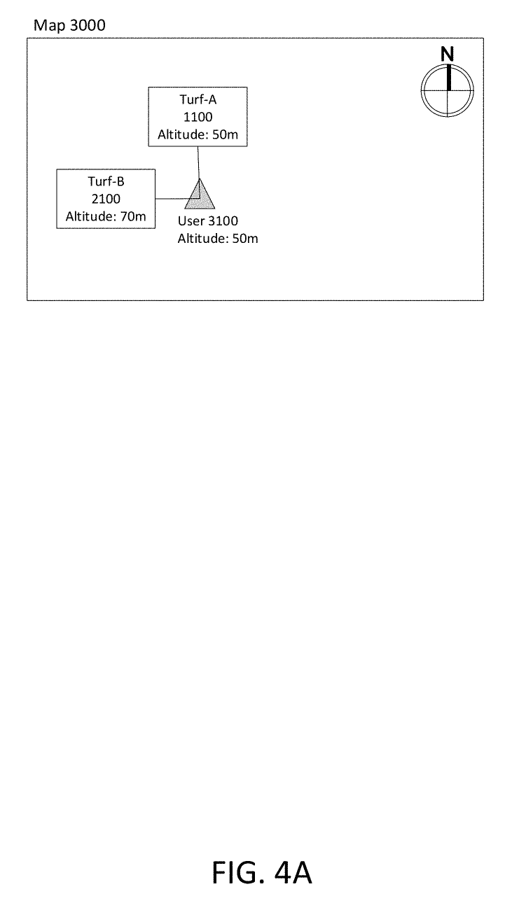

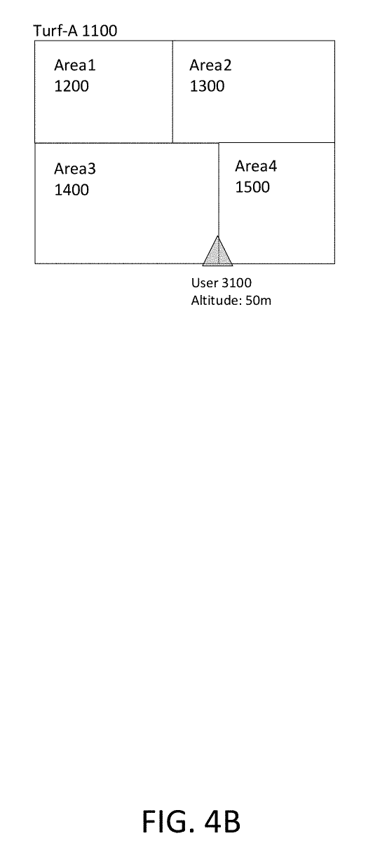

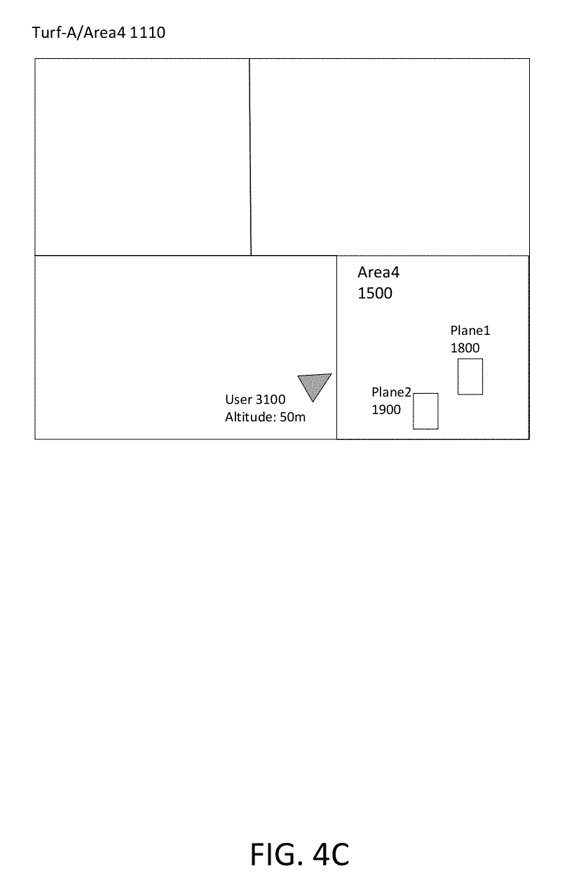

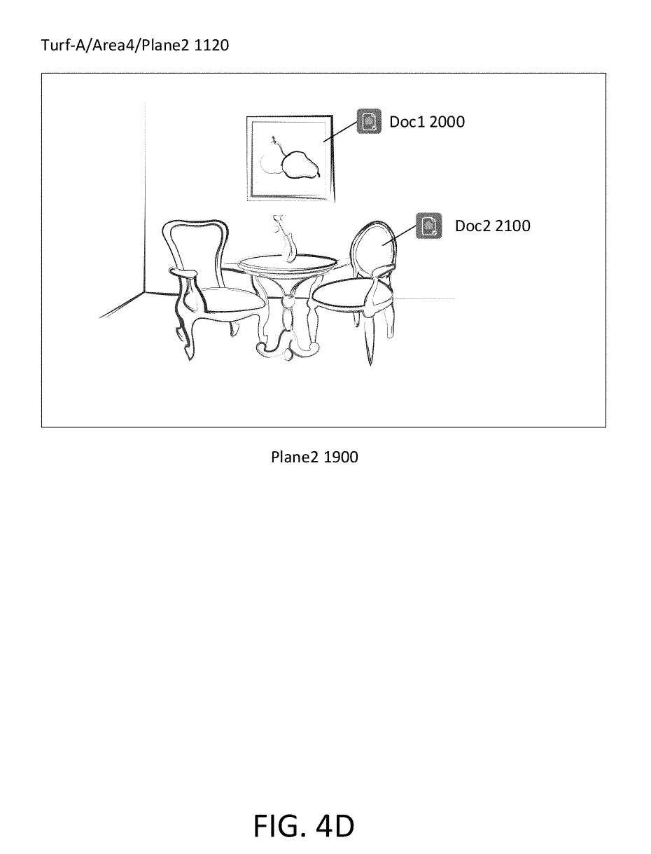

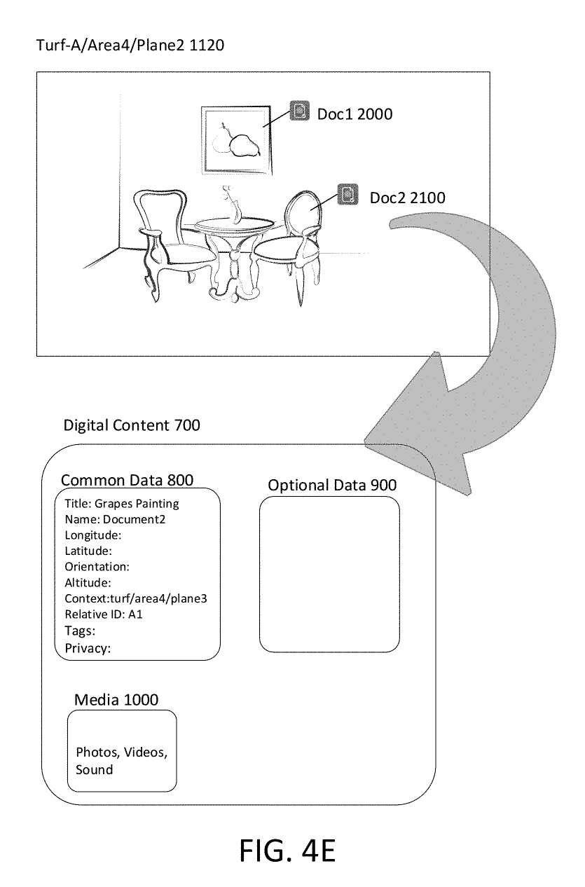

FIG. 4A illustrates how a user can navigate and enter a Turf on a map using the navigation module of the user application. In Map 3000, a triangle represents a user 3100 oriented toward due north on a map provided by the user application of this invention. The user 3100 is close to two different Turfs: Turf-A 1100 and Turf-B 2100. When a user is outside of a turf, all digital content contained inside a turf will not be visible to the user. This greatly reduce the number of markers scattered on the map, which is a big improvement over exiting arts. If this invention relies only on the GPS location, similar to what's available through existing arts, it won't be able to tell reliably which Turf is the most likely place the user 3100 wants to visit. This invention, however, uses azimuth and altitude, in addition to GPS location to detect which Turf the user is likely to enter. The GPS location gives the invention the distance between the user and each Turf. The GPS locations also allows this invention to derive that Turf-A is to the north of the user 3100. The altitude allows the user application to know whether the user and the Turfs are on approximately the same level. The azimuth allows the user application to know that the user 3100 is facing due north. This invention combines the distance, azimuth, and altitude to derive that Turf-A is the best candidate for the user 3100.

As the user 3100 enters Turf-A 1100 in FIG. 4B, the user 3100 will see only Areas in the context of Turf-A 1100. The user will not see anything outside the context of Turf-A 1100. This method of changing context as the user navigates with a mobile device is called Progressive Geographic Context Switching (PGCS.)

In the same token, as the user turns toward Area4 1500 in FIG. 4C, the user will enter Area4 1500. The context will now switch to Turf-A/Area4 1110. This sequence of geographic context names separated by “I” is called context path. As a user enters or exits geographic contexts, the user application will keep track of the context path. Now the user will only see the two Planes created in Area4 1500.

As the user moves around in Area4 1500, this invention will match the azimuth with the orientation of the planes with similar altitude and pick the closest one to present to the user. If the user is facing east in this example, the user will see Plane2 1900 in FIG. 4D. The Plane may contain one or more photos of the eastern view of the containing Area4. In FIG. 4D, there is only one photo of the living room with two document markers: Doc1 2000, and Doc2 2100 on the photo.

In FIG. 4E, the user can tap on the document markers: Doc1 2000, and Doc2 2100 to see the Digital Content 700 attached to the physical objects. The context path is Turf-A/Area4/Plane2 1120.

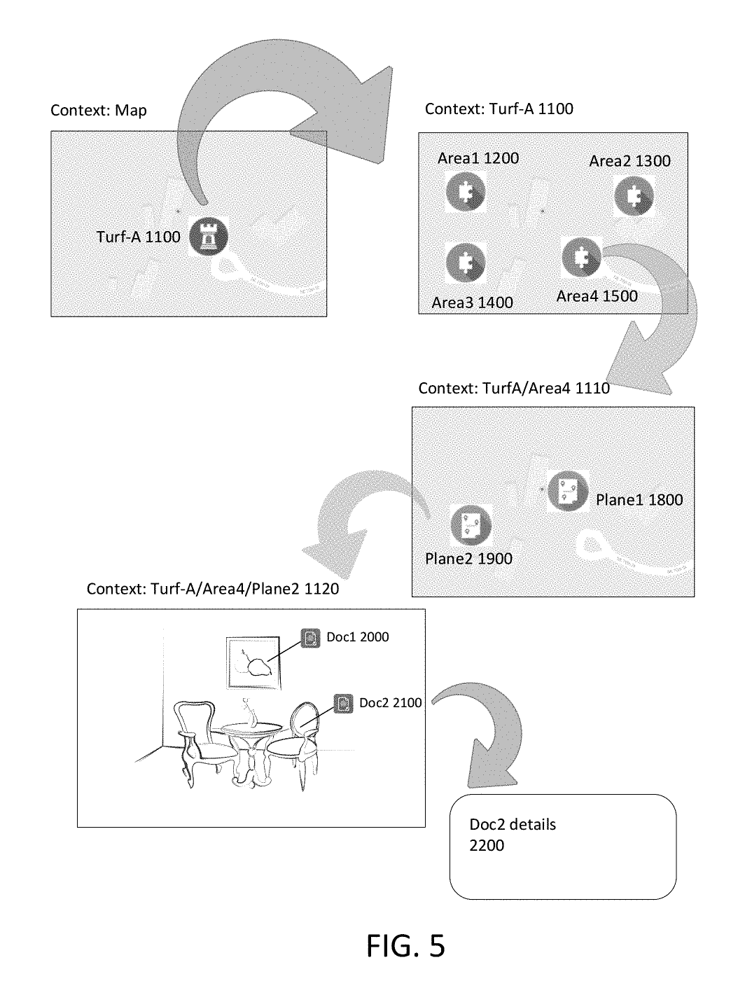

FIG. 5 is another rendition of the similar design in that instead of using polygons as boundaries for the geographic contexts, we use one GPS location as the center of each geographic context. The net effect is that each geographic context can now be represented by a marker on the map. Once the user enters Turf-A 1100, the user will see only areas in this turf. The context will be changed to Turf-A 1100. When the user enters Area4 1500, the context will switch to Turf-A/Area4 1110. Now the user can only see digital content in Area4: Plane1 1800 and Plane2 1900. When the user picks Plane2 1900, the context will switch to Turf-A/Area4/Plane2 1120 and the user will see a photo of a living room in this example. Here on Plane 2 1900, there are two documents attached to physical objects on the plane. The user can select the document of interest by tapping on the marker representing the document.

In addition to attaching documents to physical objects on Plane photos, this invention provides another technique of associating documents to real physical objects by using relative ID's. For each document an author would like to associate with a physical object, the user can assign a relative ID when creating the document. This relative ID can be any combination of alphanumeric characters with at least one character. It is unique only in the context of its containing geographic context. For example, there may be two geographic context named Garden and Garage. Both contexts can have a document with relative ID A-1. Now we can print or write the label ID A-1 in a sticker and place it on a real physical object, such as an apple tree located in the Garden geographic context. When a user navigates to the apple tree, the user application of our invention will switch the context to Garden. The user can simply enter relative ID A-1 in the user application, and the application will be able to show the user the document with relative ID A-1 in the Garden context. The use of relative ID is similar in purpose to the use of QR code or URL but QR code and URL has to be globally unique whereas relative ID does not. Moreover, the relative ID is geographic context sensitive, whereas the QR code or URL is not. In addition, URL is too long to enter on the mobile device, whereas Progressive Geographic Context Switching makes relative ID short and easy to enter. In order to scan a QR code, the QR code needs to be in full view while a user is scanning it. In a crowded museum, for example, a user can easily enter a relative ID whereas a portion or all of the QR code may be blocked by the crowd. Furthermore, when a user is in a car, it would be difficult to scan a QR code passing by whereas a user can easily enter a relative ID even on a moving vehicle.

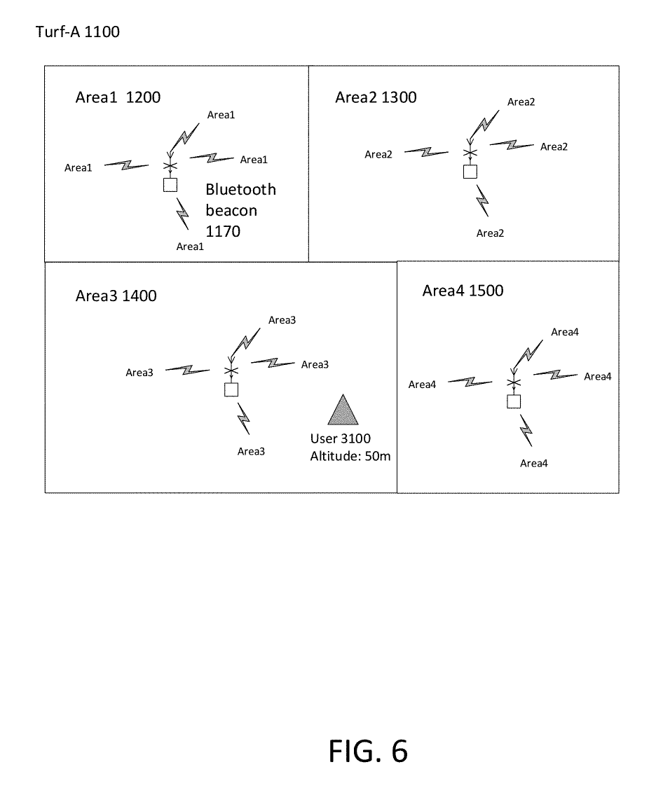

This invention relies on GPS locations, altitude, and azimuth to detect the closest geographic context. When the GPs signal is bad, the application would present a list of nearby geographic contexts for the user to choose. The owner of the Turf, however, can enhance the accuracy and reliability of geographic context detection by installing Bluetooth-enabled beacons at different spots. A beacon is usually a small, battery-powered transmitter that broadcasts a unique ID via a Bluetooth low energy antenna. FIG. 6 shows that Areal 1200 of Turf-A 1100 has a Bluetooth beacon 1170 which broadcasts its area name Areal to the user application of this invention. The user application can easily detect which geographic context the user is in and switch context accordingly.

I claim:

1. A system for attaching digital documents to any physical object, the system comprising: a content store for storing digital documents except digital media files such as photos, videos, or sound; and
a media store for storing digital media files such as photos, videos, or sound; and
a content index store for indexing digital documents by GPS location, altitude, azimuth, context path, relative ID and other searchable text fields; and
a web server with an Application Programming Interface (API) layer for handling requests coming from the user application; and
a user application which runs on a mobile device with GPS, Wi-Fi, Bluetooth capabilities and sensors for device altitude and azimuth.

2. The system of claim 1, wherein the user application comprises an authoring module for creating digital content which consists of geographic contexts and digital documents of various types.

3. The system of claim 2, wherein an author can designate a region on map as top-level geographic context called Turf. A Turf can be enclosed by a polygon on the map or it can be represented by one marker on the map.

4. The system of claim 3, wherein the top-level geographic context, Turf, can be further divided into smaller geographic contexts consisting of Areas or Planes. Each Area can be further divided into smaller Areas in a nested manner whereas Planes cannot be divided further. Similar to a Turf, an Area can be enclosed by a polygon on the map or represented by a marker on the map. A Plane is always represented by a marker on the map.

5. The system of claim 4, wherein all geographic contexts created by the authoring module will be tagged with GPS location, device altitude, and azimuth where the context was created. In addition, all geographic context will have its context path stored in the content store as well.

6. The system of claim 5, wherein all geographic contexts created by the authoring module will be indexed by the content index store on GPS location, device altitude, azimuth and context path for the purpose of Progressive Geographic Context Switching.

7. The system of claim 4, wherein a plurality of documents can be created in any geographic context. All documents are tagged with GPS location, device altitude, azimuth, and context path just like the geographic contexts.

8. The system of claim 4, wherein one or more Planes can be created in any geographic context. A Plane contains a plurality of photos of the surroundings of its containing geographic context. A document can be attached to a physical object on a Plane by placing an appropriate document marker on a Plane.

9. The system of claim 7, a document is assigned a relative ID which is unique in a geographic context, but not globally unique.

10. The system of claim 4, wherein a plurality of Bluetooth beacons can be installed to broadcast geographic context names.

11. The system of claim 1, wherein the user application comprises a navigation module for navigating digital content using the device GPS location, altitude, azimuth, and context path.

12. The system of claim 11, wherein the navigation module uses current device GPS location to query the content index store for geographic contexts near it. The navigation module further uses the device altitude and azimuth to further detect the most appropriate geographic context to present to the user.

13. The system of claim 12, wherein the navigation module prompts the user to enter a geographic context or select from a list of geographic contexts if the navigation module decides there is a plurality of choices.

14. The system of claim 13, wherein the user cannot see any digital content contained inside a geographic context unless he or she enters it.

15. The system of claim 14, wherein the navigation module maintains a context path as the user enters or exits a geographic context. Depending on the current context path, the user will only see digital content contained within the current context path.

16. The system of claim 15, wherein the navigation module allows the user to access any document inside the geographic context he or she is currently in and is authorized to access.

17. The system of claim 15, wherein the navigation module allows the user to enter a relative ID that is posted on a real physical object to access a document.
